(19) United States
(12) Patent Application Publication
(10) Pub. No.: US 2006/0260077 A1
(43) Pub. Date: Nov. 23, 2006

(54) Splunger

(76) Inventor: Robert L. Wilson, Lambertville, NJ (US)

Correspondence Address: Michael de Angeli;MICHAEL M. DE ANGELI, P.C., ATTORNEY AT LAW, 60 INTREPID LANE, JAMESTOWN, RI, 02835, US

(21) Appl. No.: 11/404,113

(22) Filed: Apr. 14, 2006

Related U.S. Application Data
(60) Provisional application No. 60/672,100, filed on Apr. 18, 2005.

(51) Int. Cl. B08B 9/04

(52) U.S. Cl. 15/104.16; 15/104.33

(57) ABSTRACT

A combined toilet brush and plunger, termed the Splunger, combines both functions in one tool. In order to do so, the Splunger can be converted, conveniently and without tools, from a substantially rigid configuration in which a mop head is effectively mounted on one end of a rigid handle, so as to be employed as a conventional toilet brush, to a flexible configuration in which the mop head is extended on a flexible but incompressible member, so that it can be forced into the constricted passages of a toilet, clearing it out.

### CROSS-REFERENCE TO RELATED APPLICATION

This complete application claims priority from provisional patent application Ser. No. 60/672,100, filed Apr. 18, 2005.

### FIELD OF THE INVENTION

This invention relates to an improved household tool combining in one device, termed herein the “Splunger,” the principal functions of toilet brush and plunger, thus realizing simplification and economy.

### BACKGROUND OF THE INVENTION

Typically one requires a toilet brush, essentially a brush or mop head on a rigid handle, to clean a toilet, while one needs a plunger, commonly a large rubber suction cup also on a rigid handle, to force clogs out of the constricted “trap” passageways of the toilet (especially the new limited-flow toilets, which are very susceptible to clogging) and into the soil plumbing. See Scott U.S. Pat. No. 2,473,452. Alternatively, a flexible but non-compressible shaft—such as a stiff spring—can be used as the shaft for a tool designed to be thrust through the trap and associated passages and thus clear any clogging. See Browning U.S. Pat. No. 1,154,369 and Palmer U.S. Pat. No. 4,025,982. In either case both a brush and a separate device for clearing clogging are normally required. It would desirable to provide a single tool providing both cleansing and trap-clearing functions, and such is the object of the invention. Other aspects and objects of the invention will appear as the discussion thereof proceeds.

### SUMMARY OF THE INVENTION

The present invention provides a combined toilet brush and trap clearing device, termed the Splunger herein, which combines both functions in one tool. In order to do so, the Splunger can be converted, conveniently and without tools, from a substantially rigid configuration in which a mop head mounted on one end of a rigid handle can be employed as a conventional toilet brush, to a flexible configuration in which the mop head is extended on a flexible but incompressible member, so that it can be thrust into the constricted trap passages of a toilet, clearing clogs therefrom.

The Splunger comprises a rigid tubular outer handle, closed at proximal and distal ends by cap members having central bores therethrough. A small mop head is mounted on a distal end of a flexible but incompressible tubular member (abbreviated hereinafter simply as the “FIT” member), extending through the bore in the distal cap on the outer handle; the FIT member can be made using a length of reinforced plastic tubing, such as used for water piping and the like. The fitting by which the mop head is attached to the FIT member has an internal thread on its proximal end, for receiving a corresponding thread on the distal end of a control rod extending coaxially within the FIT member. A second fitting, also with an internal thread for receiving the thread on the control rod, is secured to the proximal end of the FIT member; the control rod extends out through this fitting and through the bore in the proximal cap on the outer handle, and has a knob on its proximal end.

The control rod is a few inches longer than the outer tubular member. Thus, when the coupling on the control rod is threaded into the fitting at the distal end of the FIT member and pushed fully into the outer handle, the mop head on the distal end of the FIT member protrudes slightly from the end of the tubular member; in this position, the mop head is substantially rigidly supported by the outer tubular member, so that the Splunger can be used as a toilet brush. When it is desired to use the Splunger as a clog-clearing tool, the coupling on the control rod is unthreaded from the fitting at the distal end of the FIT member, the control rod is pulled most of the way out of the tubular member and FIT member, and the coupling threaded into the fitting at the proximal end of the FIT member. The control rod can then be pushed into the tubular handle, forcing the length of the FIT member out of the bore in the cap at the distal end of the tubular member. When this has been accomplished, so that the mop head is carried only by the FIT member, which is flexible but incompressible, as described above, the mop head can be urged into the passages of the toilet. It has been found that a properly sized mop head functions as a sort of hydraulic ram or piston, and is very effective in clearing clogged toilets. After use, the coupling on the control rod can again be threaded into the fitting at the mop head, and the control rod drawn rearwardly, so as to take a storage position in which the mop head is surrounded by a cup member, for convenience in storage and ease of cleaning. In a preferred embodiment, the mop head fits relatively tightly into a first inner “wringer” cup member, forcing water from the mop head, which is perforated for drainage; the first cup member may be surrounded by a second, imperforate cup member, so as to control dripping of water.

### BRIEF DESCRIPTION OF THE DRAWINGS

The invention will be better understood if reference is made to the accomplaynig drawings, in which:

FIG. 1 shows an elevational view with the Splunger in its “storage” configuration;

FIG. 2 is a similar view, with the Splunger in the “toilet brush” configuration;

FIG. 3 is a similar view, with the Splunger in the “plunger” configuration;

FIG. 4 is a cutaway, cross-sectional view, with the Splunger in the storage configuration of FIG. 1;

FIG. 5 is a cross-sectional view of a toilet, showing the Splunger in use in its plunger configuration; and

FIG. 6 is a partial view corresponding to FIG. 4, illustrating an alternative embodiment.

### DETAILED DESCRIPTION OF THE PREFERRED EMBODIMENTS

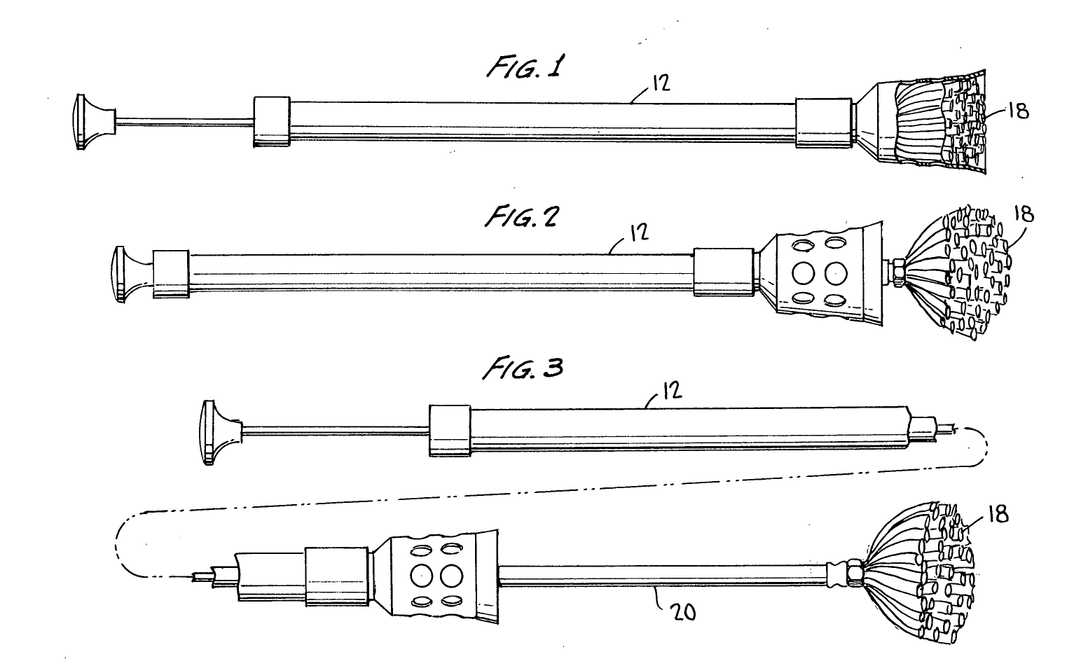

As discussed above, the Splunger of the invention is a tool that can be used in a “toilet brush” configuration (FIG. 2), in which the mop head is essentially rigidly connected to the handle, to enable effective scrubbing; a “trap cleaning device” configuration (FIG. 3), in which the mop head can be forced through a curved “trap” passageway in a toilet (as illustrated by FIG. 5), clearing it out, and a “storage” configuration (FIG. 1). FIG. 4 illustrates the inventive construction that makes this versatility possible. The Splunger 10 comprises a rigid tubular outer handle 12, closed at proximal and distal ends 12a and 12b, respectively, by cap members 14 and 16, respectively, having central bores therethrough. A mop head 18 is mounted on a distal end of a flexible but incompressible tubular “FIT” member 20, extending through the bore in the distal cap 16 on the outer handle 12; the FIT member 20 can be made using a length of reinforced plastic tubing, such as used for household water piping and the like. Alternatively, the FIT member can be made from a long spring, such as the type employed for closing screen doors; but as the metallic spring will tend to scar the porcelain of the toilet, the reinforced plastic tubing mentioned is generally preferred. The fitting 22 by which the mop head is attached to distal end of the FIT member 20 has an internal thread 22a on its proximal end, for receiving a corresponding thread 24 on the distal end of a control rod 26 extending coaxially within the FIT member 20. A second fitting 28, also with an internal thread 28a for receiving the thread 24 on the control rod 26, is secured to the proximal end 20a of the FIT member 20; the control rod 26 extends out through this fitting 28 and through the bore in the proximal cap 14 on the outer tubular handle 12, and has a knob 36 (or is otherwise adapted to be gripped by a user's hand) on its proximal end 30.

The control rod 26 is a few inches longer than the outer tubular handle 12. Thus, when the thread 24 on the control rod 26 is threaded into the fitting 22 at the distal end of the FIT member 20, and the control rod 26 is pushed fully into the outer handle 12, the mop head 18, also fixed to the fitting 22 on the distal end of the FIT member 20, protrudes slightly from the end of the tubular handle member 12, as shown in FIG. 2. In this configuration, the mop head 18 is substantially supported by the outer tubular member 12. That is, although the mop head is mounted to the flexible FIT member 20, the FIT member does not protrude from the fitting 22 enough to allow significant flexibility. Accordingly, in this position the Splunger can be used as a toilet brush, which requires a substantially rigid connection between the handle 12 and mop head for effective scrubbing.

When it is desired to use the Splunger as a clog-clearing tool, the thread 24 on the control rod 26 is unthreaded from the fitting 22 at the distal end of the FIT member 20; the mop head fits within wringer cup member 34 (which is fixed to tubular handle 12) sufficiently snugly that the cup member 34 holds the mop head, allowing the control rod to be unthreaded from fitting 22. (The snug fit also allows cup 34 to serve as a wringer, forcing water from the mop head when drawn into cup 34.) Then the control rod 26 is pulled most of the way out of the tubular handle 12 and FIT member 20, and thread 24 is threaded into the fitting 28 at the proximal end of the FIT member 20. The control rod 26 can then be pushed back into the tubular handle 12, forcing the length of the FIT member 20 out of the bore in the cap 16 at the distal end of the tubular member 12, so as to take the position in FIG. 3. When this has been accomplished, so that the mop head 18 is carried only by the FIT member 20, which is flexible, but not incompressible, as described above, the mop head 18 can be thrust into the trap and associated passages of the toilet to clear clogs therefrom, as illustrated in FIG. 5. It has been found that a properly sized mop head 18 functions very effectively as a sort of hydraulic ram or piston, and is very effective in clearing clogged toilets. A useful technique for so clearing clogs is to place the cup member 34 firmly over the flush drain in the toilet, so that the FIT member cannot kink, with the control rod 26 pulled back with respect to the tubular member 12, and then press axially on the control knob 36, so that the control rod 26 forces the mop head 18 into the trap and associated passages, clearing any clogs. Of course, the mop head 18 can be thrust into and withdrawn from the toilet repeatedly as needed to unclog the water passages.

Thus, it will be appreciated that an important constructional feature of the Splunger is that the control rod 26 can be selectively affixed to fittings 22 and 28 at either end of the FIT member 20; in the preferred embodiment, the control rod is selectively threadedly engaged with either fitting. With the control rod engaged with the proximal end of the FIT member 20, the FIT member 20 can be fully extended by pushing the control rod 26 out of the tubular handle 12. In this circumstance the FIT member 20 is flexible, allowing it to pass along the convoluted trap passages of a toilet; the mop head 18 serves as a sort of hydraulic piston, effectively clearing clogs. When the control rod 26 is withdrawn, so that the distal tip of the FIT 20 is captured by the fitting 16 at the distal end of the tubular handle 12, the FIT 20 is within the tubular handle 12. At this point the mop head is substantially supported by the fitting 16, and the Splunger can be used as a toilet brush. The control rod can be threaded to the fitting at either end of the FIT member 20 for this use, although it is perhaps more convenient to have the control rod 26 threaded to the fitting at the distal end of the FIT member 20, so that the control rod 26 does not protrude awkwardly.

After use, the thread 24 on the control rod 26 can again be threaded into the fitting 22 at the distal end of the FIT member 20, and the control rod 26 and FIT member 20 drawn rearwardly, so as to take a storage position (see FIG. 1) in which the mop head 18 is pulled into and surrounded by a wringer cup member 34, for convenience in storage and ease of cleaning. Again, the fit of the mop head 18 in inner cup member 34 is sufficiently firm that the mop head is gripped frictionally within the wringer cup member 34, so that the control rod 26 can be effectively threaded thereinto; this good fit also causes water to be effectively squeezed from the mop head as it is drawn into the cup member, so that little dripping takes place thereafter, and providing an effective self-cleaning function. As illustrated, cup member 34 may be perforated, for better drying of mop head 18.

Other aspects of the construction of the Splunger that have not been discussed are as follows. (Of course, the invention is not limited to the specific constructional details shown.) The mop head includes a central fitting to which fitting 22, threaded to accept coupling 24, can readily be attached. An 0-ring 32 can be interposed between an inward-extending ring on cap 16 (which can be modified from a conventional PVC plastic pipe coupling) and the distal end of tubular handle 12, to provide a seal between tubular handle 12 and FIT member 20.

As mentioned, FIT member 20 can usefully be made from a length of reinforced plastic water tubing, as used in various home plumbing systems; this material is sufficiently flexible to be thrust readily through the convoluted trap and associated passages of a toilet, yet is sufficiently rigid that it does not tend to kink, so that force exerted on the proximal end of the control rod is efficiently transmitted to the mop head at the distal end of the FIT. Other materials providing these characteristics and no disqualifications can also be used; for example, a long steel spring such as used for screen doors, or a plumber's snake, would likely be functionally adequate but might tend to scar the inner surfaces of the toilet, and/or to rust. Unreinforced rubber tubing would presumably be too likely to kink, preventing efficient transfer of force to the mop head, but reinforced rubber hose, e.g, as used for fuel lines, might be adequate. Likewise, while the tubular handle 12 is preferably a length of PVC tubing, other plastics and other classes of materials might be acceptable if sufficiently rigid to serve as a handle. Accordingly, terms such as “flexible but incompressible” and “rigid” as used herein to describe these components are to be understood to convey these functional requirements, not to limit the invention. Similarly, the control rod could be made of tubular material if sufficiently rigid to transfer force so as to thrust the mop head into the toilet passages to free clogs therein.

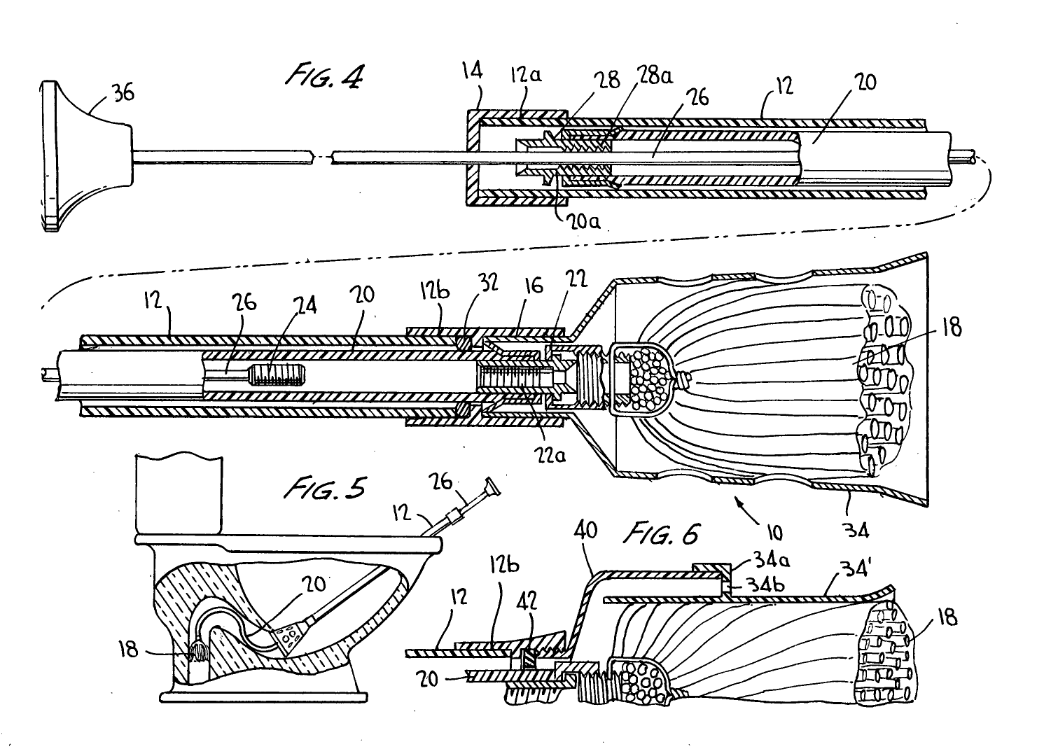

FIG. 6 shows an alternative construction of the wringer cup assembly, which is presently preferred. In this embodiment, wringer cup member 34′ is essentially cylindrical, to efficiently wring water from mop head 18 as the mop head is drawn into the cup 34′. Wringer cup member 34′ is supported by an outer cup member 40 that is secured to tubular handle 12. More specifically, a radially- and proximally-extending flange 34a mates with outer cup member 40 such that they can be glued together. Perforations 34b provide an escape path for water forced out of the mop head 18 as it is drawn into wringer cup 34′. An 0-ring or resilient washer 42 is confined between the distal end 12b of tubular handle 12 and outer cup 40, providing a seal between the FIT 20 and handle 12. As illustrated, the distal end of wringer cup 34′ is flared slightly, to provide a good seal against the exit orifice of the toilet and ensure efficient removal of clogs.

Having described the invention in detail, the following constructional features of the preferred embodiment—to which the invention is not to be limited, the scope of the invention being limited only by the appended claims—and the advantages provided thereby will be of interest:

FEATURE: The “Splunger” is a small attractive unit adapted both to clean the bowl and unclog the water trap of modem flush toilets. ADVANTAGE: One can do the jobs of cleaning and unclogging with a single tool.

FEATURE: The mop head is designed to clean the toilet bowl and is of a size that will conform to fit a clogged water trap as a hydraulic ram or piston, so as to push a clog over and out of the trap. ADVANTAGE: Novel approach to solve the problem of the clogged toilet.

FEATURE: The mop head, being provided with inner and outer cup members, allows water to be wrung from the mop head, while all manual operations can be carried out from the opposite end of the handle. ADVANTAGE: Cleaning the mop head is simple, neat, and easy, while one's hands will not come in contact with contaminated water.

FEATURE: The mop head wringer housing, that is, the inner cup receiving the mop head, is designed so as to divert water out through drain holes pointing away from the hand held position of the device. ADVANTAGE: Any water pulled into the wringer cup will not enter the hollow handle shaft of the Splunger.

FEATURE: The mop head outer cap is designed to enter the bowl drain and stop at the proper position to ensure smooth entry of the mop head into the water trap. ADVANTAGE: Positioning the cup housing properly assures a smooth entrance of the mop head into a clogged water trap.

FEATURE: Use of plastic tubing as the flexible but incompressible member allows one to push the mop head through the water trap but not mark the ceramic toilet bowl. ADVANTAGE: No permanent marks are left, as might occur if a metal coil spring or plumber's “snake” were used.

FEATURE. Construction is of durable plastic and stainless steel. ADVANTAGE: Designed to outlast other toilet cleaning devices.

FEATURE: Mop-head is easily replaceable. ADVANTAGE: If the mop-head wears out one need not replace a complete unit.

While a preferred embodiment of the invention has been shown and described in detail, the invention should not be limited thereby.

What is claimed is:

1. A combined toilet brush and plunger, comprising:
a rigid tubular outer handle;
a flexible but incompressible tubular member, disposed within the interior of said tubular outer handle, and arranged to slide longitudinally therewithin;
a mop head mounted on a distal end of the flexible but incompressible member;
a control rod disposed within the flexible but incompressible tubular member and arranged to slide longitudinally therewithin, a proximal end of said control rod extending out of a proximal end of said outer handle and adapted to be gripped; and
wherein a distal end of said control rod is adapted to be selectively affixed to either of proximal or distal ends of said flexible but incompressible member, whereby said control rod can be affixed to a desired end of said flexible but incompressible member and manipulated to urge said flexible but incompressible member out of the distal end of the outer handle or to withdraw said flexible but incompressible member into the outer handle.

2. The combined toilet brush and plunger of claim 1, wherein the mop head is attached to distal end of the flexible but incompressible member by a fitting having an internal thread on its proximal end, for receiving a corresponding thread on the distal end of said control rod, such that said control rod can thereby be selectively affixed to the distal end of the flexible but incompressible member.

3. The combined toilet brush and plunger of claim 2, wherein a second fitting, also with an internal thread for receiving the thread on the control rod, is secured to the proximal end of the flexible but incompressible member, and wherein the control rod extends out through said second fitting, such that said control rod can thereby be selectively affixed to the proximal end of the flexible but incompressible member.

4. The combined toilet brush and plunger of claim 2, further comprising a distal cap fitting over the distal end of the outer handle, said distal cap having a bore therethrough for allowing passage of said flexible but incompressible member.

5. The combined toilet brush and plunger of claim 4, further comprising a cup member secured to said distal cap, wherein the mop head fits within cup member sufficiently well that the cup member frictionally secures the mop head against rotation, allowing the control rod to be unthreaded from fitting.

6. The combined toilet brush and plunger of claim 5, wherein said cup member is perforated to allow water to escape therefrom.

7. The combined toilet brush and plunger of claim 6, further comprising a second outer cup member secured to said outer handle for receiving said perforated cup member.

8. The combined toilet brush and plunger of claim 1, further comprising a proximal cap fitting over the proximal end of the outer handle, said proximal cap having a bore therethrough for allowing passage of said control rod.

9. The combined toilet brush and plunger of claim 1, wherein said flexible but incompressible member is made using a length of reinforced plastic tubing.

10. A method of use of a single tool as a toilet brush having a mop head attached substantially rigidly to a handle and as a plunger having a mop head attached to a flexible but incompressible member, said tool comprising:
a rigid tubular outer handle;
a flexible but incompressible tubular member, disposed within the interior of said tubular outer handle and arranged to slide longitudinally therewithin;
a mop head mounted on a distal end of the flexible but incompressible member;
a control rod disposed within the flexible but incompressible tubular member and arranged to slide longitudinally therewithin, a proximal end of said control rod extending out of a proximal end of said outer handle; and
wherein a distal end of said control rod is adapted to be selectively affixed to either of proximal or distal ends of said flexible but incompressible member,
wherein said method of use of the tool as a plunger comprises the steps of affixing said control rod to the proximal end of said flexible but incompressible member and manipulating said control rod to urge said flexible but incompressible member out of the distal end of the outer handle,
wherein said method of use of the tool as a toilet brush comprises the steps of affixing said control rod to the distal end of said flexible but incompressible member and manipulating said control rod in order to withdraw said flexible but incompressible member into the outer handle.

11. The method of claim 10, wherein the mop head is attached to the distal end of the flexible but incompressible member by a fitting having an internal thread secured to said mop head and to said flexible but incompressible member at its proximal end, for receiving a corresponding thread on the distal end of said control rod, such that the step of affixing said control rod to the distal end of the flexible but incompressible member for use of the tool as a toilet brush is performed by threading the thread on the distal end of the control rod into the corresponding thread on said fitting.

12. The method of claim 12, wherein the control rod is somewhat longer than the outer tubular handle, so that when the control rod, having been threadedly affixed to the fitting to which the mop head is attached, is urged fully into the tubular handle, the flexible but incompressible member extends somewhat from the handle, and wherein a wringer cup within which said mop head fits relatively snugly is disposed around the distal end of said tubular handle, whereby if said control rod is withdrawn water is effectively wrung from said mop head by said wringer cup.

13. The method of claim 12, wherein said wringer cup is perforated.

14. The method of claim 13 wherein a second outer cup is affixed to said tubular handle over said wringer cup.

15. The method of claim 10, wherein a fitting with an internal thread for receiving a thread on the control rod is secured to the proximal end of the flexible but incompressible member, and wherein the control rod extends out through said second fitting, such that the step of affixing the distal end of said control rod to the proximal end of the flexible but incompressible member for use of the tool as a plunger is performed by threading the thread on the distal end of the control rod into said fitting on the proximal end of the flexible but incompressible member.

16. The method of claim 15, wherein at least a first cup is secured to the distal end of said tubular handle, and whereby said tool is used as a plunger by urging an open end of said cup against a water passage to be cleared, and pushing said control rod into said handle, such that said mop head is urged by said flexible but incompressible member into the water passage.
